(19) United States
(12) Patent Application Publication
(10) Pub. No.: US 2004/0060747 A1
(43) Pub. Date: Apr. 1, 2004

(54) Mini-excavator with closed-loop hydrostatic travel

(76) Inventors: Michael D. Wetzel, Bismarck, ND (US); John W. Henline, Bismarck, ND (US); Russ A. Honeyman, Bismarck, ND (US); Steven M. Sundvor, Bismarck, ND (US); Henry J. Weber, Bismarck, ND (US)

Correspondence Address: John Veldhuis-Kroeze, WESTMAN CHAMPLIN & KELLY, International Centre - Suite 1600, 900 South Second Avenue, Minneapolis, MN, 55402-3319, US

(21) Appl. No.: 10/255,320

(22) Filed: Sep. 26, 2002

(51) Int. Cl. B62D 55/00

(52) U.S. Cl. 180/9.44

(57) ABSTRACT

A mini-excavator includes a base supported by first and second track assemblies on which the vehicle travels. The base supports an operator support, which includes first and second travel control devices, such as travel levers. Each of first and second closed-loop hydrostatic systems of the mini-excavator are coupled between different ones of the travel control devices and the track assemblies to control the speed and direction of travel of the track assemblies. Each of the closed-loop hydrostatic systems includes a closed-loop travel motor and a closed-loop pump coupled directly to the closed-loop travel motor.

### BACKGROUND OF THE INVENTION

The present invention relates to mini-excavators or compact excavators. More particularly, the present invention relates to hydrostatic travel circuits for controlling travel of mini-excavators.

Mini-excavators (also known as compact excavators) are currently in wide use. A mini-excavator is a tracked excavator having an operating weight of less than six tons. A base portion of a mini-excavator is supported by a pair of track assemblies. The track assemblies are powered by hydraulic motors.

Current mini-excavators utilize separate open-loop hydraulic systems for the left and right side travel circuits. A system formed by the combined left and right side travel circuits minimally includes one or more open-loop pumps, two directional spool valves (one for each side) and two open-loop travel motors (one for each side). For each spool valve and open-loop travel motor combination, the pump flow is directed to the motor through the spool valve, which controls the speed and direction of the open-loop motor, in turn controlling the speed and travel direction of the corresponding track. The motor return flow is directed to tank through the spool valve, cooler and filter. The one or more open-loop pumps which drive the travel circuits require one or more external relief valves to limit motor torque.

The open-loop hydraulic systems used in current mini-excavator travel circuits introduce a number of limitations in the performance of the mini-excavators. For example, pump pressure and rotational speed is limited. Also, limited motor rotational speed results in a limited maximum travel speed of the mini-excavator.

Further, both the travel hydraulic circuits and implement hydraulic circuits share the same hydraulic pump flow. This results in a loss of travel speed and power during implement operation, and vice versa. Additional power is lost due to pressure drops in the spool valves. Also, power is lost when traveling at speeds less than the maximum speed. Since the pump generates a constant flow to each travel motor, if less flow is required by the motor (i.e., the operator desires less than maximum travel speed), the excess flow if bypassed to tank via the spool valve(s). This results in wasted or lost power.

Consequently, a mini-excavator which overcomes one or more of the above-described limitations, or other limitations not described, would be a significant improvement in the art.

### SUMMARY OF THE INVENTION

A mini-excavator includes a base supported by first and second track assemblies on which the vehicle travels. The base supports an operator support, which includes first and second travel control devices, such as travel levers. Each of first and second closed-loop hydrostatic systems of the mini-excavator are coupled between different ones of the travel control devices and the track assemblies to control the speed and direction of travel of the track assemblies. Each of the closed-loop hydrostatic systems includes a closed-loop travel motor and a closed-loop pump coupled directly to the closed-loop travel motor.

### BRIEF DESCRIPTION OF THE DRAWINGS

FIG. 1 is perspective view of a mini-excavator utilizing closed-loop hydrostatic systems for the travel circuits in accordance with the present invention.

FIG. 2 is a hydraulic circuit diagram of a prior art open-loop hydraulic system used as a travel circuit in conventional mini-excavators.

FIG. 3 is a hydraulic circuit diagram illustrating the closed-loop hydrostatic system used as a travel circuit in mini-excavators in accordance with the present invention.

FIG. 4 is a diagrammatic illustration of a portion of a mini-excavator in accordance with the present invention in which a separate implement pump is used to provide hydraulic fluid flow to at least one implement through an implement hydraulic circuit.

### DETAILED DESCRIPTION OF THE PREFERRED EMBODIMENTS

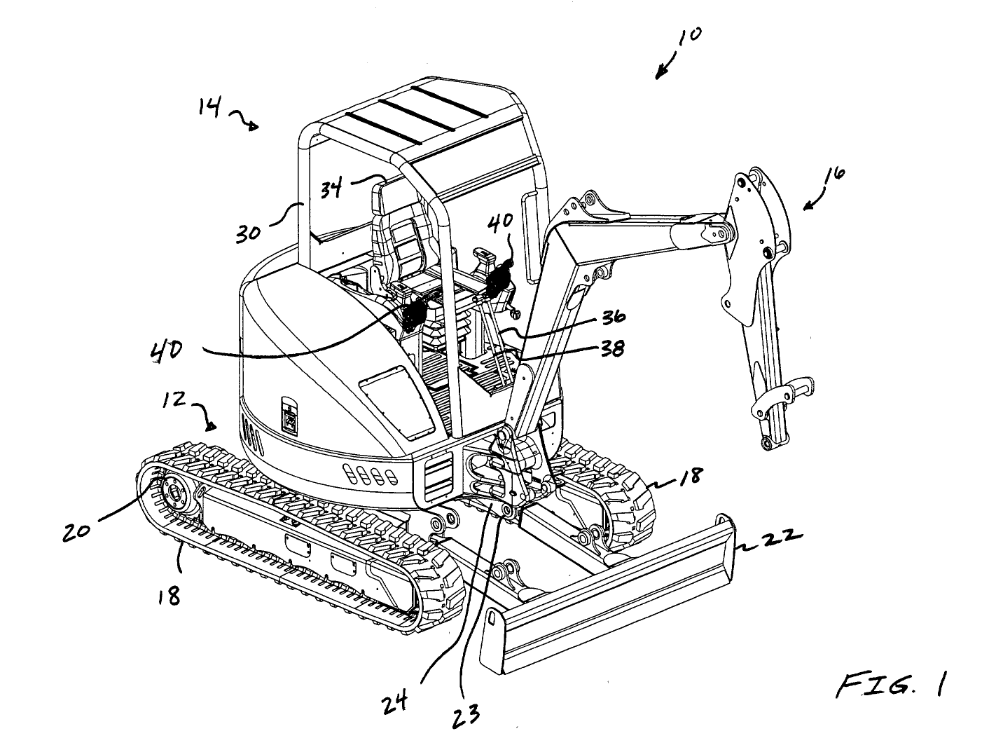

FIG. 1 is a perspective view of a mini-excavator 10 (also known as a compact excavator) according to the present invention. Mini-excavator 10 includes a base portion 12, an operator support portion 14, and an implement assembly 16 (such as a dipper assembly or other implement types commonly used with mini-excavators). Base 12 includes a pair of tracks 18 on left and right sides of the mini-excavator.

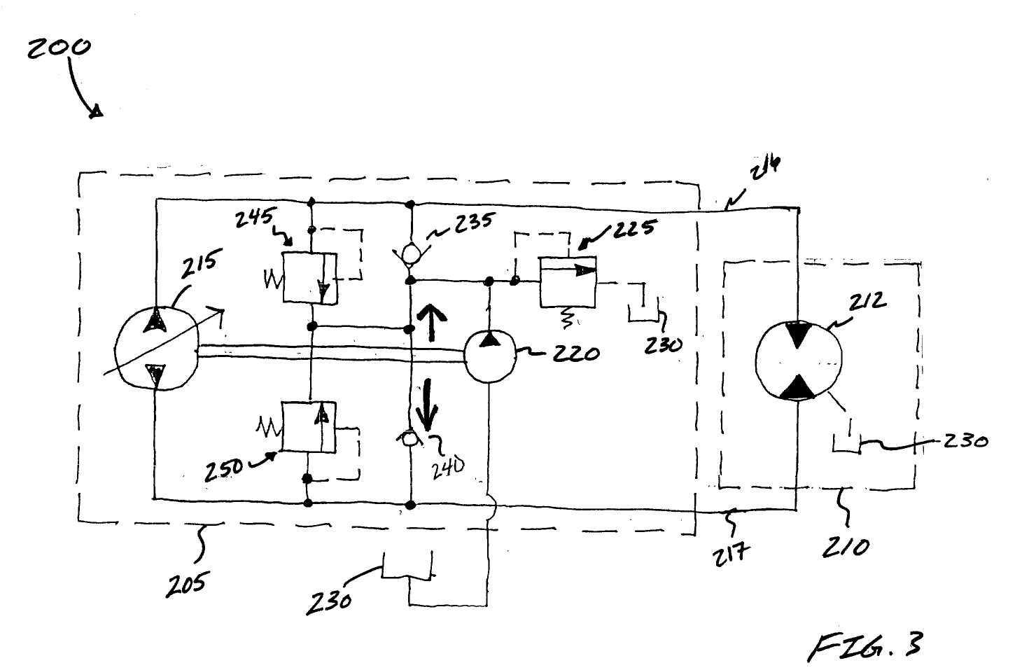

On each of the left and right sides of the mini-excavator, tracks 18 are rotatable about a pair of hubs 20 (only one hub is shown in FIG. 1). On each side of the mini-excavator, at least one of hubs 20 is driven by a closed-loop hydrostatic system 200 (shown in FIG. 3) to provide travel. Each track 18 is driven by a separate closed-loop hydrostatic system 200, though only a single system 200 is shown in FIG. 3. The closed-loop hydrostatic systems 200 are controlled by the operator through manipulation of suitable controls in operator support portion 14.

Base 12 also includes a blade 22 which is pivotally coupled to a frame 24 of the base at a pivot point 23. Hydraulic cylinders (not shown in FIG. 1) are selectively provided with hydraulic fluid under pressure from a hydraulic power circuit which is separate from closed-loop hydrostatic systems 200. The operator, upon the manipulation of appropriate controls, can raise and lower blade 22 by controlling the hydraulic power circuit.

Operator support 14 is supported by base 12 and includes a canopy or cab 30 which is rotatably coupled to the frame of base 12. While positioned on a seat 34 within canopy or cab 30, the operator can control the travel of the mini-excavator 10 using travel control devices or mechanisms, such as hand controls. In one embodiment, the hand controls include a pair of steering levers 36 and 38, as well as other joysticks 40 or other types of hand controls. Typically, first and second (for example left and right) travel control devices are each mechanically linked or coupled to a different one of two closed-loop hydrostatic systems 200, which are in turn coupled to a corresponding one of track assemblies 18 (for example via hubs 20).

Steering levers 36 and 38 (or other travel control devices) are manipulated by the operator to steer the mini-excavator 10. For example, pushing forward on lever 36 causes the closed-loop hydrostatic system 200 associated with lever 36 to drive the corresponding left or right track 18 in the forward direction. Pulling back on lever 36 causes the closed-loop hydrostatic system 200 associated with lever 36 to drive the corresponding track 18 in the reverse direction. The relative forward or rearward positions of lever 36 control the speed of travel of the corresponding track 18 in the forward or reverse directions. The same is true of lever 38 and its associated closed-loop hydrostatic system 200 and track 18. Other joysticks, such as joysticks 40, can be used by the operator to control other hydraulic accuators on mini-excavator 10.

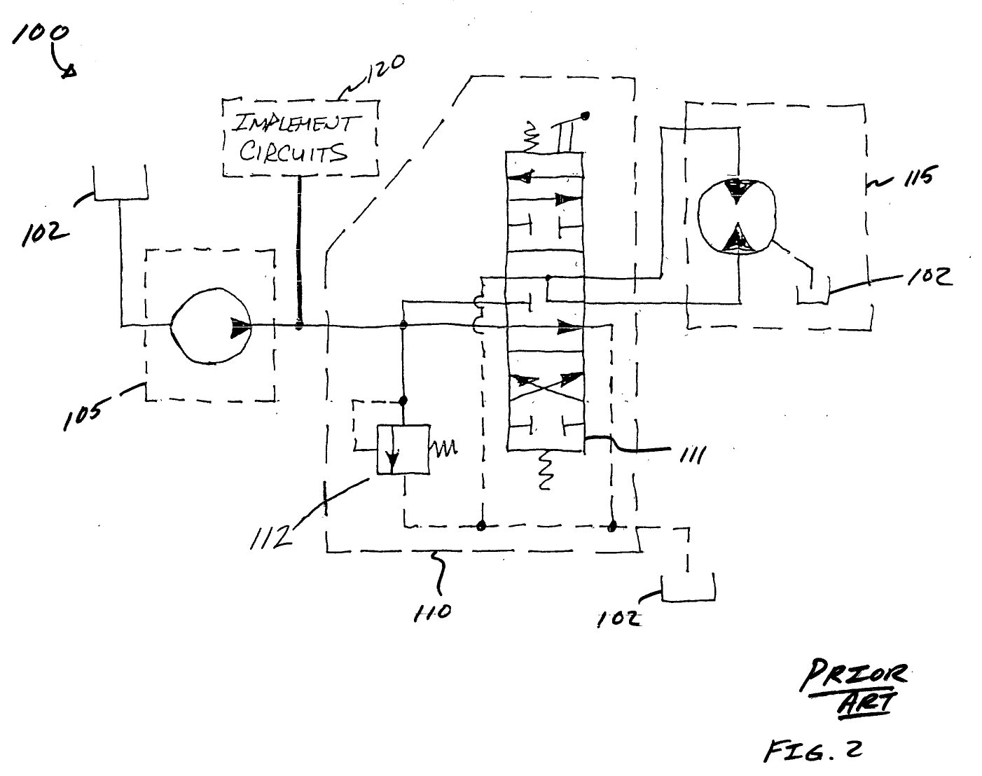

By utilizing a separate closed-loop hydrostatic system 200 for each of the left and right track travel circuits, neither of which are used to provide power to the implement circuits used to control implement assembly 16 and/or blade 22, one or more of the previously described problems with conventional mini-excavators are overcome. A more detailed description of a closed-loop hydrostatic system 200 is provided below with reference to FIG. 3. However, for purposes of illustration of the context of the invention, a description of a prior art open-loop hydraulic system travel circuit of the type typically used in mini-excavators is provided with reference to FIG. 2.

FIG. 2 is a hydraulic circuit diagram illustrating a prior art open-loop hydraulic system 100 commonly used for the travel circuits which power and control tracks 18 in conventional mini-excavators. As can be seen in FIG. 2, an open-loop pump 105 pumps hydraulic fluid from tank 102 on the low-pressure side to open-loop motor 115 via a hydraulic circuit 110. The motor then provides the pump flow to tank 102. The hydraulic circuit 110 includes a directional spool valve 111 which controls the speed and direction of hydraulic fluid flow to open-loop motor 115, as well as one or more high pressure valves 112. Thus, under the control of the operator via a mechanical linkage between spool valve 111 and one of steering levers 36 and 38, the speed and direction of travel of open-loop motor 115 is controlled in order to control a corresponding one of tracks 18. A separate open-loop hydraulic system 100 is typically used for the opposite track, but one or more components can be shared between the two systems 100.

As noted above, this conventional mini-excavator travel circuit design suffers from a number of disadvantages. For example, the pressure and rotational speed of pump 105 and motor 115 can be limited, thereby limiting the travel speed and power of the mini-excavator. Also, in addition to the travel hydraulic circuit 110 which controls the open-loop travel motor 115, implement circuits 120 are also hydraulically connected to open-loop pump 105 and share the same pump flow. The implement circuit(s) and the travel circuit can be connected in series or in parallel. Thus, when using implements 16 or blade 22, travel speed will necessarily be reduced. Likewise, when the mini-excavator is traveling, power available to the implement circuits 120 will be limited. Further, some power is lost due to pressure drop in the spool valve and due to wasted or lost power resulting from a portion of the constant flow provided to each travel motor being bypassed to tank via the spool valve.

To address one or more of the above-mentioned problems, disclosed is a closed-loop hydrostatic system 200 which can be used for the travel circuits on a mini-excavator 10 in accordance with the present invention. Closed-loop hydrostatic system 200 shown in FIG. 3 can be used as one of the left and right travel circuits which control left and right tracks 18 in response to manipulation of levers 36 and 38 shown in FIG. 1. An identical closed-loop hydrostatic system 200 can be used for the other side as well. Thus, the overall system includes at least two closed-loop pumps and two closed-loop travel motors as is discussed below.

As shown in FIG. 3, each closed-loop hydrostatic system 200 includes a closed-loop pump 205 and a closed-loop travel motor 210. Closed-loop pump 205 includes a variable displacement bi-directional pump 215. Pump 215 provides the hydraulic fluid pump flow directly to a bi-directional motor 212 of closed-loop travel motor 210 via one of fluid paths 216 and 217 between the pump and motor. As shown in FIG. 3, pump 215 provides the pump flow to motor 212 in either direction without the use of a spool valve. Both speed and direction of motor 212 of closed-loop travel motor 210 are controlled by pump 215, by controlling its hydraulic fluid displacement rate and direction. The motor return flow is also provided directly back to pump 215 via the other of paths 216 and 217.

Closed-loop pump 205 also includes a charging pump 220. Charging pump 220 has an associated pressure relief valve 225 which can direct pump flow directly to tank 230 in excessive pressure situations. Charging pump 220, along with check valves or replenishing valves 235 and 240, maintains a minimum back pressure to facilitate operation of closed-loop pump 205. High pressure relief valves 245 and 250 divert pump flow from the high pressure side during excessive high pressure conditions to prevent damage to the components of closed-loop pump 205 or closed-loop travel motor 210.

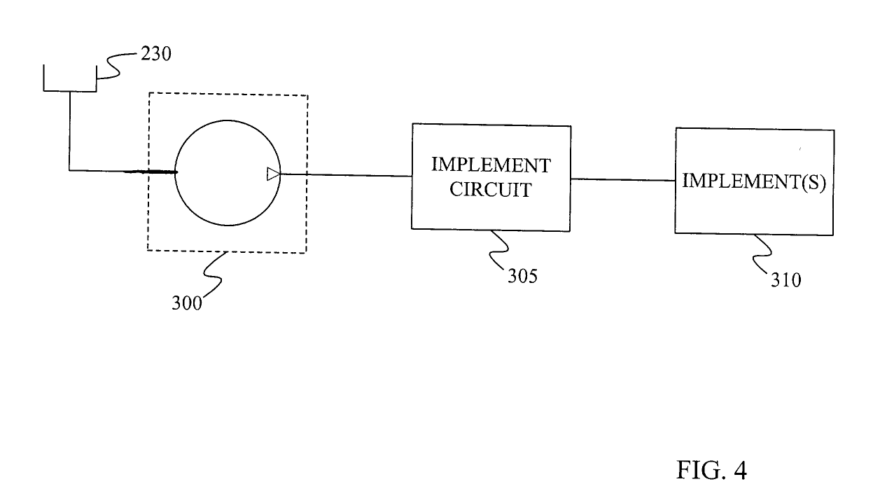

FIG. 4 is a block diagram illustration of a portion of mini-excavator 10 in accordance with the present invention. As can be seen in FIG. 4, mini-excavator 10 includes an implement pump 300, separate from the closed-loop pumps in systems 200 used to control travel of the mini-excavator. The implement pump 300 pumps hydraulic fluid from tank 230 through an implement circuit 305 (such as a spool valve) to provide power to one or more implements 310. Implements 310 can be, for example, implement assembly 16, blade 22, or other implements. By powering implements 310 using a pump 300 which is separate from the closed-loop pumps of systems 200, travel speed and implement operation have significantly less effect on each other, if any.

Closed-loop hydrostatic system 200 provides numerous advantages over open-loop system 100. For example, there is less pressure drop due to the fact that the pump 215 and motor 210, 212 are directly connected. Also, power use is maximized because the pump generates only the flow required by the travel motor, as opposed to the conventional mini-excavator hydraulic system configuration in which the pumps generate maximum flow and the corresponding spool valves control the direction and flow rates provided to the motor.

Generally, the closed-loop configuration of system 200 allows the utilization of smaller pumps due to the corresponding higher allowable rotation speeds. In addition or in the alternative, system 200 can facilitate the use of smaller motors due to higher allowable pump pressures. Mini-excavator travel speeds can be increased due to higher motor rotational speeds which can be achieved. Mini-excavator speed control can be improved, with system 200 facilitating infinitely variable speed control of each track without losses. Also, the increased hydraulic efficiency provided by system 200 can reduce fuel consumption. Also, overall power utilization is maximized by minimizing pressure loss between the pump and the motor.

Although the present invention has been described with reference to preferred embodiments, workers skilled in the art will recognize that changes may be made in form and detail without departing from the spirit and scope of the invention.

What is claimed is:

1. A mini-excavator comprising:
a base;
first and second track assemblies supporting the base;
an operator support supported by the base, the operator support including first and second travel control devices; and
first and second closed-loop hydrostatic systems, wherein the first closed-loop hydrostatic system is coupled to the first travel control device and to the first track assembly and controls the speed and direction of travel of the first track assembly in response to a position of the first travel control device, and wherein the second closed-loop hydrostatic system is coupled to the second travel control device and to the second track assembly and controls the speed and direction of travel of the second track assembly in response to a position of the second travel control device.

2. The mini-excavator of claim 1, wherein each of the first and second closed-loop hydrostatic systems comprises:
a closed-loop travel motor coupled to and driving a corresponding one of the first and second track assemblies; and
a closed-loop pump coupled directly to the closed-loop travel motor through first and second fluid paths, the closed-loop pump providing all of its pump flow directly to the closed-loop travel motor through at least one of the first and second fluid paths.

3. The mini-excavator of claim 2, wherein the closed-loop travel motor of each of the first and second closed-loop hydrostatic systems includes a bi-directional travel motor, and wherein the closed-loop pump of each of the first and second closed-loop hydrostatic systems includes a variable displacement bi-directional pump which provides the pump flow to the closed-loop travel motor in either of two directions through one of the first and second fluid paths.

4. The mini-excavator of claim 3, wherein the closed-loop travel motor of each of the first and second closed-loop hydrostatic systems returns the pump flow to the closed-loop pump through the other of the first and second fluid paths.

5. The mini-excavator of claim 3, wherein the closed-loop pump of each of the first and second closed-loop hydrostatic systems further comprises:
a charge pump having a high pressure side and a low pressure side;
a first replenishing valve coupled between the high pressure side of the charge pump and the first fluid path, the first replenishing valve allowing charge pump flow from the charge pump to the first fluid path, and preventing flow from the first fluid path toward the charge pump;
a second replenishing valve coupled between the high pressure side of the charge pump and the second fluid path, the second replenishing valve allowing charge pump flow from the charge pump to the second fluid path, and preventing flow from the second fluid path toward the charge pump; and
wherein the charge pump maintains a minimum back pressure in the closed-loop pump.

6. The mini-excavator of claim 5, wherein the closed-loop pump of each of the first and second closed-loop hydrostatic systems further comprises a first high pressure relief valve coupled between the high pressure side of the charge pump and tank.

7. The mini-excavator of claim 6, wherein the closed-loop pump of each of the first and second closed-loop hydrostatic systems further comprises:
a second high pressure relief valve coupled between the first fluid path and the high pressure side of the charge pump; and
a third high pressure relief valve coupled between the second fluid path and the high pressure side of the charge pump.

8. The mini-excavator of claim 3, wherein the first and second travel control devices include first and second travel levers, respectively.

9. The mini-excavator of claim 3, and further comprising:
at least one implement;
an implement pump separate from the closed-loop pump of each of the first and second closed-loop hydrostatic systems; and
an implement hydraulic circuit coupling the at least one implement to the implement pump in order to provide hydraulic power to the at least one implement.
